(19) United States
(12) Patent Application Publication
(10) Pub. No.: US 2013/0061248 A1
(43) Pub. Date: Mar. 7, 2013

(54) METHOD FOR EXECUTING A PROGRAM FOR PROCESSING DATA, AND CORRESPONDING SYSTEM

(71) Applicant: Dieter WEILER, Pulheim (DE)

(72) Inventor: Dieter WEILER, Pulheim (DE)

(21) Appl. No.: 13/667,472

(22) Filed: Nov. 2, 2012

Related U.S. Application Data
(63) Continuation of application No. PCT/EP2011/057292, filed on May 6, 2011.

(30) Foreign Application Priority Data
May 6, 2010 (DE) 10 2010 019 783.1

(51) Int. Cl. G06F 9/54

(52) U.S. Cl. 719/317

(57) ABSTRACT

A technique involves executing a program for processing data including at least one subprogram, in which an administrator controls at least two local agents and provides the latter with at least one subprogram, wherein the administrator controls the local agents on the basis of control data including at least one of the following items on information: a) the location of the data to be processed and b) the available computation capacity on the local agents, wherein the administrator controls at least the transport of data to the local agents and the allocation of subprograms to the local agents. A method and a system disclosed herein advantageously allow high-performance computation systems which are cost-effective and highly scalable to be set up. The costs incurred for so-called supercomputers at the time at which this application is filed can thus be considerably reduced with the same computation power and a reduced energy consumption.

### CROSS REFERENCE TO RELATED APPLICATIONS

This Patent Application is a Continuation of International Patent Application No. PCT/EP2011/057292 filed on May 6, 2011, entitled, “METHOD FOR EXECUTING A PROGRAM FOR PROCESSING DATA, AND CORRESPONDING SYSTEM”, the contents and teachings of which are hereby incorporated by reference in their entirety.

The present invention relates to a method for executing a program for processing data, and a corresponding system. This involves a method in which a program includes at least one subprogram which is executed on at least two local agents.

Providing high-performance computers and supercomputers for data processing has become increasingly more costly in recent years. In addition to special-purpose computers which rely on specialized high-performance hardware, which entail high purchase and maintenance costs, increasing use has been made of so-called computer clusters. Computer clusters represent a computer network in which the tasks to be performed are distributed over multiple computers, operating in parallel, which usually include the very same hardware.

On this basis, the object of the present invention is to at least partially overcome the disadvantages known from the prior art.

This object is achieved by a method and a system having features disclosed herein. Further disclosed herein are advantageous refinements.

The method according to the invention for executing a program for processing data, including at least one subprogram, is based on an administrator controlling at least two local agents and being provided with at least one subprogram, the administrator carrying out the control of the local agents based on control data which include at least one of the following information items:
a) the localization of the data to be processed, and
b) the available computing capacity on the local agents,
   the administrator controlling at least the transport of data to the local agents and the allocation of subprograms to the local agents.

An administrator is understood to mean in particular a computer, on the hardware of which appropriate software runs. A local agent is understood to mean in particular a computer, on the hardware of which appropriate software runs. The transport of data is understood to mean readout of the data from corresponding memories and transmission of the data to another memory. In addition, a subprogram is generally understood to mean a computing task.

A local agent includes the following components in particular:
1. Hardware, in particular including at least one memory medium such as a hard disk, a flash memory, a solid-state drive (SSD)), or the like, a graphics processor (graphics processing unit (GPU)), at least one microprocessor, and appropriate interfaces; and
2. Software.

The local agent in particular has software which loads data, executes computing tasks, and stores results. The local agent in particular contains information which includes the dedicated capacity based on computing power, as well as stored data and connected systems. This information is preferably administered internally on the local agent, and in particular is communicated to the administrator. In particular, the local agent is also suitable and intended to determine the resource usage for each computing task and to communicate same to the administrator.

In particular, the local agents have standard technology-based processors which include a defined interface, a runtime environment, an internal data memory, and a metadata memory, and which are defined by same. Local agents are in particular able to independently execute appropriate assignments in the form of subprograms and/or computing tasks. The method according to the invention is preferably carried out in such a way that a local agent communicates the appropriate results of the subprogram and/or of the computing task to the administrator. Data are preferably stored either in a local file system on the local agent, in particular in compressed and/or encrypted form, or in an external application memory.

A local agent preferably includes at least one disk storage unit including at least one hard disk, a rapid data memory (random access memory (RAM)), a rapid arithmetic unit including at least one graphics processor, and a microprocessor for processing the communication and transfer operations. The local agents are preferably controlled in such a way that the data to be processed are retained on the local internal memory of the graphics processors as a type of “in-memory database.”

Local agents have the following capabilities and functions:
Retrieving (loading) external data;
Executing local computations;
Executing external computations;
Writing external data;
Responding to queries or requests regarding external data;
Responding to queries or requests regarding internal data; and
Delivering internal data.

“Executing external computations” is understood to mean the control of carrying out a computation on an external computer, i.e., the control of another computer. In this case, the local agent thus also takes over control tasks for a third computer. This is particularly advantageous when an existing system is to be expanded, and/or the migration of applications from other computers into the system according to the present invention is to take place in steps.

The method according to the invention is preferably carried out in such a way that the administrator is able to rely on a certain number of typical local agents (a typical pool or cluster, for example), while at the same time being in contact with a further number (one or more) of potential local agents which are usually not controlled by the administrator. However, if computing power is available on the potential local agents which is not used on the potential local agent for other processes, the administrator may use this computing power for carrying out at least one subprogram. In particular, it is thus possible to use the resources of a graphics processor on a potential local agent which are not needed at that particular time.

The method according to the invention may in particular also be used with local agents having different hardware. Thus, it is possible, for example, to easily expand the appropriately used system with new local agents without interfering with operations.

A uniform programming language should preferably be provided, by means of which the system is perceivable to the user as a single computer system. A mechanism is preferably provided which converts the uniform programming language into a programming language that is understandable on the respective local agents.

The control of the local agents is preferably carried out by an administrator which includes a central database (inventory) of the local agents, and a metadatabase. The metadatabase contains information concerning the location of the stored data, i.e., information from which conclusions may be drawn concerning on which unit, for example a local agent or an external application memory, the data are stored, and/or information concerning the computing ability, i.e., information concerning the basic and/or the instantaneously available computing capacity on the respective local agents.

The inventory documents for each local agent the computing abilities, i.e., the basic computing capacity of the local agent, a performance indicator, and/or a usage indicator. Based on these data, in one preferred embodiment a decision is made concerning on which local agent the particular computing task is executed.

The basic computing capacity is understood to mean the entire computing power of the corresponding local agent which is basically possible, or possible in principle. The performance indicator is a measure for the capability of the corresponding local agent. Factors such as the power of the at least one central microprocessor (central processing unit (CPU)), of the at least one graphics processor, if applicable, the size of the memory, etc., are mapped in the performance indicator. The usage indicator is understood to mean a measured variable into which variables such as the instantaneous capacity utilization of the CPU and of the graphics processor, if applicable, the computing time used, etc., are entered.

The entire functional spectrum of the programming environment is preferably defined by a programming environment with the aid of a metalanguage. The programming environment preferably includes an event interface and a scheduler which are responsible for controlled execution of the particular computing tasks on the participating local agents. An event interface is understood to mean a defined interface of the programming environment via which events may be sent to the programming environment for initiating an action. These events may be, for example, interrupts or a system change, for example the notification that a certain file exists, that data content has changed, etc.

The provisioning, i.e., the distribution of the subprograms over the various local agents, preferably takes place as follows: For each computing task, the usage times, i.e., the required time per computing task, is/are documented in the local agents and communicated to the administrator. In the inventory of the administrator, an accounting is preferably made of the used times, based on stored computing costs for each local agent. The inventory of the administrator contains the costs per unit time and per data volume for each local agent.

The provisioning takes place in particular in such a way that the processing of the particular program is optimized with respect to energy efficiency, cost efficiency, and/or time efficiency. It is preferably possible to delegate identical computing tasks to local agents having different designs, in particular different architectures. This advantageously allows the migration of certain programs from old hardware to new hardware with simultaneous redundancy during the migration phase.

The following procedure is preferably carried out for storing the data which are generated and required in the method according to the invention: Distributing the possible computing tasks over multiple computers results in redundancy, which increases the fault tolerance. The data are preferably stored in the local agents as persistent data, i.e., as nonvolatile data. These persistent data are not lost, even after the subprogram terminates or if the local agent unforeseeably shuts down. As a result of this persistence within the local agents, it may be ensured that the function of the local agents is maintained, even if the communication channels between the local agents and the administrator fail.

The data are preferably stored on the local agent in a standard file format in compressed and/or encrypted form.

The communication between the local agents and/or between the local agents and the administrator preferably takes place via mobile agents. A mobile agent is in particular a code, in particular an executable code, which may be transferred between local agents and the administrator, and between two local agents. Mobile agents have in particular the property of being able to transport states, data, and/or program code. This means that, for example, also new, required program code may be transferred to one or more local agents.

According to one advantageous embodiment of the method according to the invention, at least a portion of the local agents contain at least one graphics processor (graphics processing unit (GPU)), and the corresponding processing of data takes place, at least in part, on the graphics processor.

Processing of the data on a graphics processor has advantages over processing on a conventional processor. Conventional processors are designed in such a way that, in addition to the typical computing operations, they perform a number of tasks that are necessary for operation of a computer. This decreases the performance, in particular the performance per unit purchase price. In contrast, graphics processors usually have a high basic computing power, in particular per unit purchase price. Therefore, it is advantageous to operate using local agents having one or more graphics processors for executing the subprograms.

According to another advantageous embodiment, for the control the administrator relies on control data which include at least one of the following information items:
a) The type of the at least one graphics processor of a local agent;
b) The number of graphics processors of a local agent;
c) The basic computing power of the at least one graphics processor of a local agent; and
d) The capacity utilization of the graphics processor of the local agent.

In particular, the administrator may allocate larger, or multiple, subprograms to local agents which have more graphics processors than other local agents. In particular, taking into account the instantaneous capacity utilization of the graphics processor of the local agent may result in advantageous better and faster execution of the program. The type and/or the basic computing power of the at least one graphics processor may likewise advantageously be taken into account in distributing the subprograms over the various local agents for an effective load distribution. Preferably at least three of these information items are taken into account in the control by the administrator, i.e., in the distribution of the computing tasks or subprograms over the various local agents.

According to another advantageous embodiment of the method according to the invention, the local agents report at least one of the following parameters to the administrator:
a) The required computing time for the subprogram allocated to the local agent;
b) The required memory capacity for processing the subprogram allocated to the local agent;
c) The basic computing power of the local agent;
d) The basic memory capacity of the local agent; and
e) The basic configuration of the local agent.

The communication of at least one of these parameters to the administrator, preferably at least two of these parameters to the administrator, allows the administrator to effectively manage the overall program and its distribution over the individual local agents.

According to another advantageous embodiment of the method according to the invention, the administrator maintains the following data of the local agents:
a) The energy consumption for at least one capacity utilization state of the local agent;
b) The operating costs of the local agent per unit time;
c) The operating costs of the local agent per data volume; and
d) The transport costs for the transport of code between local agents and the administrator.

Knowledge of the energy consumption for at least one capacity utilization state of the local agent, in particular for full capacity utilization, and preferably for two or more capacity utilization states, allows energy-efficient control by the administrator. Knowledge of the operating costs of the local agent allows cost-optimized control by the administrator. The transport costs result, for example, from the distance of the local agent from the administrator, and the line capacity, as well as the costs for providing the line.

According to another advantageous embodiment of the method according to the invention, the subprograms are distributed over the local agents based on an algorithm which minimizes at least one of the following variables:
a) The energy consumption for executing the program;
b) The resulting costs for executing the program; and
c) The time required for executing the program.

Based on the information available to the administrator, optimization may be made with respect to the lowest possible energy consumption, the lowest possible costs, or the shortest possible time for executing the program. Alternatively, two of these variables or all three variables may be optimized, it being possible to provide weighting, for example for the lowest possible energy consumption while accepting a slightly longer computing time, or the like.

In addition, a system is proposed which is suitable and intended for carrying out the method according to the invention. This system includes hardware components, and in particular may also be included on a data carrier. The system hardware preferably includes at least three arithmetic units including one administrator and two local agents. The details disclosed for the method may be transferred and applied to the system according to the invention, wherein suitable means are provided for carrying out the corresponding method steps.

The invention is briefly explained below with reference to the appended FIGURE, which schematically shows an example embodiment. The invention is not limited to the details shown in the FIGURE.

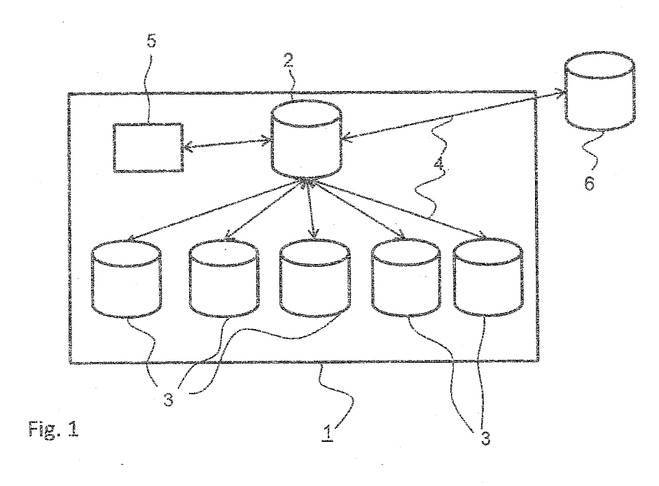

FIG. 1 schematically shows a system 1 for data processing according to the present invention. The system 1 includes an administrator 2 and multiple local agents 3. The local agents are connected to the administrator 2 via appropriate connections 4, which for the sake of clarity are not all provided with a reference numeral. Each local agent 3 includes multiple graphics processors (not shown), disk memory (not shown), and a microprocessor (not shown). The administrator 2 contains a metadatabase and an inventory. For each local agent 3, information is stored in these databases concerning the basic computing capacity of the local agent 3, the capacity utilization of the local agent, and the performance indicator and usage indicator of the local agent. In addition, the metadatabase of the administrator 2 stores the location of any required data, either on a local agent 3 or on an external application memory 5, as well as the basic computing capacity of the individual local agents 3. Based on these data, the administrator 2 distributes the subprograms over the local agents 3.

The local agents 3 have graphics processors which are used for computing the computing tasks/subprograms. These graphics processors are inexpensive, thus allowing high computing power to be cost-effectively provided.

A potential local agent 6 is also shown which does not belong to the system 1, but which is likewise connectable to the administrator 2. In the event of full capacity utilization of the system 1 and only partial capacity utilization of the potential local agent 6, the latter may be integrated into the system 1 at least temporarily, thus on the one hand increasing the computing power of the system 1, and on the other hand making meaningful use of the available resources in the potential local agent 6.

The method according to the invention and the system 1 according to the invention advantageously allow the construction of high-performance computing systems which are cost-effective and easily scalable. Thus, the costs incurred at the time of filing of the present patent application for so-called supercomputers, with the same computing power and decreased energy consumption, may be significantly reduced.

### LIST OF REFERENCE NUMERALS

1 System
2 Administrator
3 Local agent
4 Connection
5 External application memory
6 Potential local agent

1. Method for executing a program for processing data, including at least one subprogram, wherein an administrator controls at least two local agents and is provided with at least one subprogram, the administrator carrying out the control of the local agents based on control data which include at least one of the following information items:
a) the localization of the data to be processed, and
b) the available computing capacity on the local agents,
the administrator controlling at least the transport of data to the local agents and the allocation of subprograms to the local agents.

2. Method according to claim 1, wherein at least a portion of the local agents contain at least one graphics processor (graphics processing unit (GPU)), and the corresponding processing of data takes place, at least in part, on the graphics processor.

3. Method according to claim 2, wherein for the control, the administrator relies on control data which includes at least one of the following information items:
a) the type of the at least one graphics processor of a local agent;
b) the number of graphics processors of a local agent;
c) the basic computing power of the at least one graphics processor of a local agent; and
d) the capacity utilization of the graphics processor of the local agent.

4. Method according to claim 1, wherein the local agents report at least one of the following parameters to the administrator:
a) the required computing time for the subprogram allocated to the local agent;
b) the required memory capacity for processing the subprogram allocated to the local agent;
c) the basic computing power of the local agent;
d) the basic memory capacity of the local agent; and
e) the basic configuration of the local agent.

5. Method according to claim 1, wherein the administrator maintains the following data of the local agents:
a) the energy consumption for at least one capacity utilization state of the local agent;
b) the operating costs of the local agent per unit time;
c) the operating costs of the local agent per data volume; and
d) the transport costs for the transport of code between local agents and the administrator.

6. Method according to claim 5, wherein the subprograms are distributed over the local agents based on an algorithm which minimizes at least one of the following variables:
a) the energy consumption for executing the program;
b) the resulting costs for executing the program; and
c) the time required for executing the program.

7. System for carrying out a method for executing a program for processing data, including at least one subprogram, wherein an administrator controls at least two local agents and is provided with at least one subprogram, the administrator carrying out the control of the local agents based on control data which include at least one of the following information items:
a) the localization of the data to be processed, and
b) the available computing capacity on the local agents,
the administrator controlling at least the transport of data to the local agents and the allocation of subprograms to the local agents.
